(19) United States
(12) Patent Application Publication
(10) Pub. No.: US 2002/0102184 A1
(43) Pub. Date: Aug. 1, 2002

(54) Liquid dispenser

(76) Inventor: Rochester Tiao-Te Co, Hsinchu City (TW)

Correspondence Address: PILLSBURY WINTHROP, LLP, P.O. BOX 10500, MCLEAN, VA, 22102, US

(21) Appl. No.: 09/770,206

(22) Filed: Jan. 29, 2001

(51) Int. Cl. B01L 3/02

(52) U.S. Cl. 422/100; 73/864.01

(57) ABSTRACT

A liquid dispenser includes an elongated tube formed with a first opening, and a closed shell connected to the tube and formed with a second opening aligned axially with and in fluid communication with the first opening. The shell has a portion that is resilient and that is compressible so as to generate a suction force when the portion is pressed and is subsequently released.

### BACKGROUND OF THE INVENTION

1. Field of the Invention

This invention relates to a liquid dispenser, more particularly to a disposable liquid dispenser for taking a liquid sample and for dispensing dropwise the sample to an analyzing device.

2. Description of the Related Art

FIGS. 1 and 2 illustrate a conventional disposable liquid dispenser 10 for taking a liquid sample, such as urine and the like, and for dispensing dropwise the sample to an analyzing device for making a diagnosis, such as pregnancy diagnosis. The liquid dispenser 10 is made of plastic, and has an elongated lower tubular portion 11 and an upper enlarged portion 12 extending from the lower tubular portion 11. The enlarged portion 12 is elastic and is compressible so as to generate a suction force in the tubular portion 11 when the enlarged portion 12 is pressed and is subsequently released. The suction force enables the liquid dispenser 10 to take the liquid sample to be analyzed into the tubular portion 11. The sample is then dispensed to the analyzing device by pressing the enlarged portion 12.

The aforesaid liquid dispenser 10 is disadvantageous in that it is rather difficult to control a predetermined amount of the liquid sample to be dispensed to the analyzing device and that an excessive amount of liquid sample may be dispensed when the enlarged portion 12 is over compressed. Moreover, since the holding position for holding the liquid dispenser 10 is located at the enlarged portion 12, it is relatively inconvenient to carry the liquid dispenser with the liquid sample therein and there is a possibility of accidental dropping of the liquid sample.

### SUMMARY OF THE INVENTION

Therefore, it is an object of the present invention to provide a liquid dispenser that is capable of overcoming the aforementioned drawbacks.

According to the present invention, a plastic liquid dispenser for dropwise dispensing liquid comprises: an elongated tube having a closed first top end, an open first bottom end opposite to the first top end, a first peripheral wall extending between the first top and bottom ends and confining a first receiving space, and a first opening formed in the first peripheral wall adjacent to the first top end; and a closed shell having a second top end, a second bottom end opposite to the second top end, a second peripheral wall that extends between the second top and bottom ends, that confines a second receiving space, and that is connected sidewise to the tube, and a second opening formed in the second peripheral wall and aligned axially with and in fluid communication with the first opening, the second peripheral wall having an upper portion that is resilient and that is compressible so as to generate a suction force in the first and second receiving spaces when the upper portion of the second peripheral wall is pressed and is subsequently released, the second opening being formed in the upper portion of the second peripheral wall, the first bottom end of the tube protruding downward relative to the second bottom end of the shell.

### BRIEF DESCRIPTION OF THE DRAWINGS

In drawings which illustrate an embodiment of the invention,

FIG. 1 is a front view of a conventional disposable liquid dispenser;

FIG. 2 is a side view of the liquid dispenser of FIG. 1;

FIG. 3 is a front view of a disposable liquid dispenser embodying this invention;

FIG. 4 is a cross-sectional view of the liquid dispenser taken along line VI-VI of FIG. 3; and

FIG. 5 is a side view of the liquid dispenser of FIG. 3.

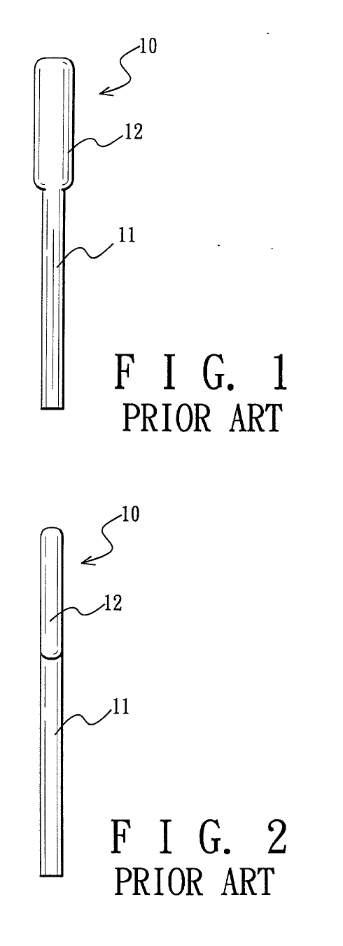

### DETAILED DESCRIPTION OF THE PREFERRED EMBODIMENT

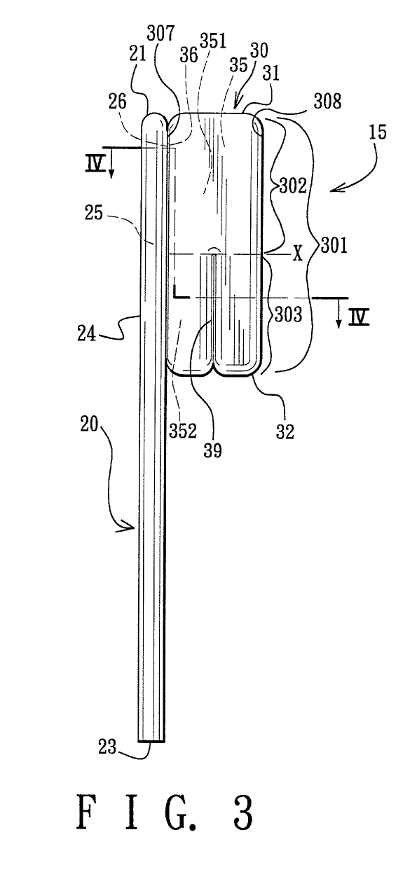

FIGS. 3 to 5 illustrate a disposable liquid dispenser 15 embodying this invention for taking a liquid sample, such as urine and the like, and for dispensing dropwise the sample to an analyzing device for making a diagnosis, such as pregnancy diagnosis. The liquid dispenser 15 is made of transparent plastic, and includes: an elongated tube 20 having a closed first top end 21, an open first bottom end 23 opposite to the first top end 21, a first peripheral wall 24 extending between the first top and bottom ends 21, 23 and confining a first receiving space 25, and a first opening 26 formed in the first peripheral wall adjacent to the first top end 21; and a closed shell having a second top end 31, a second bottom end opposite to the second top end 31, a second peripheral wall 301 that extends between the second top and bottom ends 31, 32, that confines a second receiving space 35, and that is connected sidewise to the tube 20, and a second opening 36 formed in the second peripheral wall 301 and aligned axially with and in fluid communication with the first opening 26. The first bottom end 23 of the tube 20 protrudes downward relative to the second bottom end 32 of the shell 30. The second top end 31 of the shell 30 is substantially flush with the first top end 21 of the tube 20.

The shell 30 is generally rectangular in shape. The second peripheral wall 301 has opposite front and rear side walls 305, 306 extending between the second top and bottom ends 31, 32, and opposite left and right side walls 307, 308 interconnecting the front and rear side walls 305, 306. The second opening 36 is formed in the left side wall 307 adjacent to the second top end 31. The left side wall 307 of the shell 30 is integrally formed with the tube 20.

The liquid dispenser 15 further includes a structure reinforcing rib 39 that extends upright from the second bottom end 32 and that extends between and that interconnects the front and rear side walls 305, 306. The rib 39 is integrally formed with the shell 30. The second peripheral wall 301 has an upper portion 302 that extends downward from the second top end 31 to a level corresponding to a top edge of the rib 39 (indicated as reference character “X” in FIG. 3), and a lower portion 303 that extends from the upper portion 302 to the second bottom end 32. The upper portion 302 of the second peripheral wall 301 is resilient and is compressible so as to generate a suction force in the first and second receiving spaces 25, 35 when the upper portion 302 of the second peripheral wall 301 is pressed and is subsequently released. The rib 39 enhances the structural strength of the lower portion 303 of the second peripheral wall 301, thereby permitting the lower portion 303 to have a hardness that is sufficient to prevent accidental dropping of the liquid sample when the lower portion 303 is held by the user. The second receiving space 35 has upper and lower spaces 351, 352 that are respectively confined by the upper and lower portions 302, 303 of the second peripheral wall 301. The upper space 351 of the second receiving space 35 has a volume greater than that of the first receiving space 25.

When in operation, the liquid sample fills the first receiving space 25 in the tube 20, while excess amount of the liquid sample enters into the lower space 352 of the second receiving space 35 in the shell 30. As such, a fixed amount of the liquid sample, i.e. an amount substantially equal to the volume of the first receiving space 25, can be dispensed by using the liquid dispenser 15 of this invention.

Preferably, the second top end 31 is spaced apart from the second opening 36 by a vertical distance (indicated as reference character “S1” in FIG. 5) that is sufficient to prevent the liquid sample from being entrapped at a corner defined by the second top end 31 of the shell 30 and the left side wall 307 of the second peripheral wall 301.

Preferably, the lower space 352 of the second receiving space 35 has a volume greater than a value obtained by subtracting the volume of the first receiving space 25 from the volume of the upper space 351 of the second receiving space 35 so as to assure the excess amount of the liquid sample will only fill the lower space 352 of the second receiving space 35.

Preferably, the tube 20 has an inner diameter (d) ranging from about 0.5 mm to 4 mm, and a length (indicated as reference character “S2” Z in FIG. 5), which extends from the first top end 21 to the first bottom end 23, ranging from about 50 mm to 120 mm. More preferably, the inner diameter (d) of the tube 20 ranges from about 1.5 mm to 3 mm, and the length (S2) of the tube 20 ranges from about 70 mm to 90 mm.

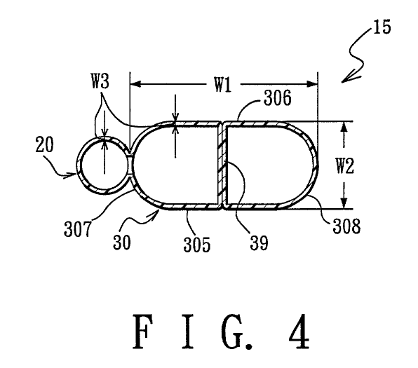

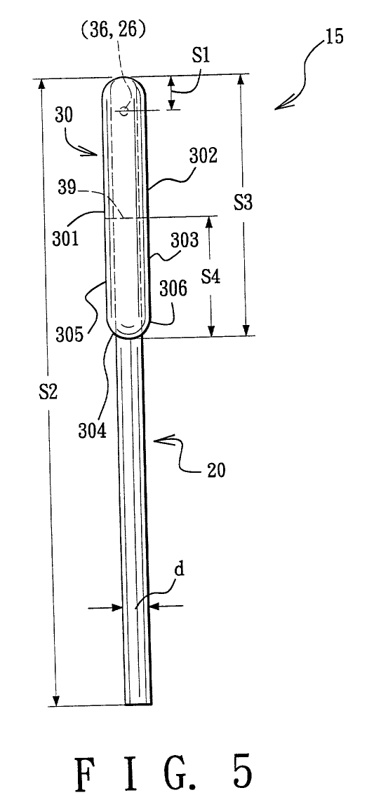

The shell 30 has a length (indicated as reference character “S3” in FIG. 5), which extends from the second top end 31 to the second bottom end 32, ranging from about 20 mm to 40 mm, a width (indicated as reference character “W1” in FIG. 4), which extends from the left side wall 307 to the right side wall 308, ranging from about 5 mm to 20 mm, and a thickness (indicated as reference character “W2” in FIG. 4), which extends from the front side wall 305 to the rear side wall 306, ranging from about 2 mm to 10 mm. More preferably, the length (S3) of the shell 30 ranges from about 25 mm to 35 mm, the width (W1) of the shell 30 ranges from about 8 mm to 12 mm, and the thickness (W2) of the shell 30 ranges from about 4 mm to 6 mm.

Preferably, the rib 39 has a length (indicated as reference character “S4” in FIG. 5), which extends from the second bottom end 32 to the top edge of the rib 39, ranging from about 5 mm to 30 mm. More preferably, the length (S4) of the rib 39 ranges from about 10 mm to 20 mm.

Preferably, the first and second peripheral walls 24, 301 have a wall thickness ranging from about 0.3 mm to 1.0 mm, and more preferably from about 0.4 mm to 0.6 mm. Preferably the vertical distance (S1) ranges from about 1 mm to 15 mm, and more preferably from about 3 mm to 10 mm.

With the design of the shell 30, the drawbacks associated with prior art can be eliminated.

With the invention thus explained, it is apparent that various modifications can be made without departing from the spirit of the present invention. It is therefore intended that the invention be limited only as recited in the appended claims.

I claim:

1. A plastic liquid dispenser for dropwise dispensing liquid, comprising:
an elongated tube having a closed first top end, an open first bottom end opposite to said first top end, a first peripheral wall extending between said first top and bottom ends and confining a first receiving space, and a first opening formed in said first peripheral wall adjacent to said first top end; and
a closed shell having a second top end, a second bottom end opposite to said second top end, a second peripheral wall that extends between said second top and bottom ends, that confines a second receiving space, and that is connected sidewise to said tube, and a second opening formed in said second peripheral wall and aligned axially with and in fluid communication with said first opening, said second peripheral wall having an upper portion that is resilient and that is compressible so as to generate a suction force in said first and second receiving spaces when said upper portion of said second peripheral wall is pressed and is subsequently released, said second opening being formed in said upper portion of said second peripheral wall, said first bottom end of said tube protruding downward relative to said second bottom end of said shell.

2. The liquid dispenser of claim 1, wherein said shell is generally rectangular in shape, said second peripheral wall having opposite front and rear side walls extending between said second top and bottom ends, and opposite left and right side walls interconnecting said front and rear side walls, said second opening being formed in said left side wall adjacent to said second top end, said left side wall being connected to said tube.

3. The liquid dispenser of claim 2, wherein said left side wall is integrally formed with said tube.

4. The liquid dispenser of claim 2, further comprising a structure reinforcing rib that extends upright from said second bottom end and that extends between and that interconnects said front and rear side walls, said rib being integrally formed with said shell, said upper portion of said second peripheral wall extending downward from said second top end to a level corresponding to a top edge of said rib.

5. The liquid dispenser of claim 4, wherein said second receiving space has an upper space confined by said upper portion of said second peripheral wall, said upper space having a volume greater than that of said first receiving space.

6. The liquid dispenser of claim 5, wherein said second peripheral wall further has a lower portion that extends from said upper portion to said second bottom end, said second receiving space further having a lower space that is confined by said lower portion of said second peripheral wall and that has a volume greater than a value obtained by subtracting the volume of said first receiving space from the volume of said upper space of said second receiving space.

7. The liquid dispenser of claim 2, wherein said second top end is substantially flush with said first top end.

8. The liquid dispenser of claim 7, wherein said second top end is spaced apart from said second opening by a vertical distance that is sufficient to prevent liquid from being entrappped at a corner defined by said second top end and said left side wall.

9. The liquid dispenser of claim 8, wherein said vertical distance ranges from about 1 mm to 15 mm.

10. The liquid dispenser of claim 8, wherein said vertical distance ranges from about 3 mm to 10 mm.

11. The liquid dispenser of claim 1, wherein said tube has an inner diameter ranging from about 0.5 mm to 4 mm.

12. The liquid dispenser of claim 1, wherein said tube has an inner diameter ranging from about 1.5 mm to 3 mm.

13. The liquid dispenser of claim 11, wherein said tube has a length, which extends from said first top end to said first bottom end, ranging from about 50 mm to 120 mm.

14. The liquid dispenser of claim 12, wherein said tube has a length, which extends from said first top end to said first bottom end, ranging from about 70 mm to 90 mm.

15. The liquid dispenser of claim 7, wherein said shell has a length, which extends from said second top end to said second bottom end, ranging from about 20 mm to 40 mm.

16. The liquid dispenser of claim 7, wherein said shell has a length, which extends from said second top end to said second bottom end, ranging from about 25 mm to 35 mm.

17. The liquid dispenser of claim 15, wherein said shell has a width, which extends from said left side wall to said right side wall, ranging from about 5 mm to 20 mm.

18. The liquid dispenser of claim 16, wherein said shell has a width, which extends from said left side wall to said right side wall, ranging from about 8 mm to 12 mm.

19. The liquid dispenser of claim 17, wherein said shell has a thickness, which extends from said front side wall to said rear side wall, ranging from about 2 mm to 10 mm.

20. The liquid dispenser of claim 18, wherein said shell has a thickness, which extends from said front side wall to said rear side wall, ranging from about 4 mm to 6 mm.

21. The liquid dispenser of claim 19, wherein said rib has a length, which extends from said second bottom end to said top edge of said rib, ranging from about 5 mm to 30 mm.

22. The liquid dispenser of claim 20, wherein said rib has a length, which extends from said second bottom end to said top edge of said rib, ranging from about 10 mm to 20 mm.

23. The liquid dispenser of claim 1, wherein each of said first and second peripheral walls has a wall thickness ranging from about 0.3 mm to 1.0 mm.

24. The liquid dispenser of claim 1, wherein each of said first and second peripheral walls has a wall thickness ranging from about 0.4 mm to 0.6 mm.

25. A plastic liquid dispenser for dropwise dispensing liquid, comprising:
an elongated tube having a top closed end and a bottom open end, and formed with a first opening adjacent to said top closed end; and
a closed shell connected to said tube and formed with a second opening aligned axially with and in fluid communication with said first opening, said shell having a portion that is resilient and that is compressible so as to generate a suction force when said portion is pressed and is subsequently released.
